(19) United States
(12) Patent Application Publication
(10) Pub. No.: US 2026/0029378 A1
(43) Pub. Date: Jan. 29, 2026

(54) FLUID CONDUIT FREEZING APPARATUS AND METHOD

(71) Applicant: DiversiTech Corporation, Duluth, GA (US)

(72) Inventors: Olusegun Adeyeye, Leeds (GB); Karl Dallimore, Leeds (GB); Lee Parsons, Leeds (GB)

(21) Appl. No.: 19/349,917

(22) Filed: Oct. 3, 2025

Related U.S. Application Data
(63) Continuation of application No. PCT/GB2024/050934, filed on Apr. 8, 2024.

(30) Foreign Application Priority Data
Apr. 6, 2023 (GB) 2305155.0

(51) Int. Cl. G01N 29/032; F16L 55/103; G01N 29/14; G01N 29/22

(52) U.S. Cl. CPC G01N 29/032; F16L 55/103; G01N 29/14; G01N 29/222

(57) ABSTRACT

Apparatus and method of use where the apparatus is configured to be attached to and/or located adjacent to a fluid conduit in use, said apparatus including a sensor assembly including at least one sonic or vibration receiving means. The sonic or vibration receiving means is configured to receive sound or vibrations propagating through and/or originating from said fluid conduit and/or fluid contained in the same.

### CROSS-REFERENCE TO RELATED APPLICATIONS

This patent application is a Continuation of PCT Patent Application PCT/GB2024/050934 filed 8 Apr. 2024; which claims a benefit of priority to United Kingdom Patent Application 2305155.0 filed 6 Apr. 2023; each of which is incorporated by reference herein in its entirety for all purposes.

### TECHNICAL FIELD

The present disclosure relates to an apparatus and method to freeze fluid in fluid conduits or pipes.

### SUMMARY

The following description refers to the freezing of water in conduits, such as pipes, usually to form a temporary plug or seal to the conduit. Commonly this is done to enable maintenance and repair of the water system. The skilled person will recognise that the present invention can be used to detect the state of the fluid in many different conduits and is not limited to the maintenance and repair of water systems.

### DESCRIPTION OF DRAWINGS

FIG. 1 shows an example of a device according to this disclosure.

FIG. 2 shows an example of an electrical layout of a device according to this disclosure.

FIG. 3A shows an example of a device according to this disclosure.

FIG. 3B shows an example of a device according to this disclosure.

### DETAILED DESCRIPTION

The use of ‘freeze kits’ to form a plug of ice in water pipes is known. Forming the plug enables work to be performed on the system without having to drain the same. To form the plug, a jacket is attached around part of the pipe in which the plug is to be formed. In most small scale applications, a volatile composition, typically a halogenated hydrocarbon, is applied to the jacket from a pressurised cannister. The evaporation of the volatile composition from the jacket cools the pipe located within the same sufficiently for ice to form.

Other systems can also use electromagnetic cooling devices and the like to cool the jacket and form the ice. Irrespective of the cooling system chosen by the user, under cooling and after 2-3 minutes (times vary depending on the size and type of pipe) the user usually hears a ‘click’ or ‘creak’ sound generated by the water expanding to form solid ice. Frost is also usually formed on the jacket from freezing water vapour in the air. The repair or maintenance work can then be conducted downstream with the ice plug preventing the flow of fluid water.

The main disadvantage of the current systems is that users can doubt whether the pipe has frozen effectively, particularly if the user does not hear the click/creak associated with the water changing into the solid phase. This can also result in the user using more volatile liquid than is necessary to freeze the pipe effectively.

It is therefore an aim of the present disclosure to provide an improved apparatus for freezing fluid conduits that addresses the abovementioned problems.

It is a further aim of the present disclosure to provide a method of freezing fluid conduits that addresses the abovementioned problems.

It is a yet further aim of the present disclosure to provide a pipe freezing system that addresses the abovementioned problems.

In a first aspect of the disclosure, there is provided an apparatus configured to be attached to and/or located adjacent to a fluid conduit in use, said apparatus including a sensor assembly including at least one sonic or vibration receiving means characterised in that said sonic or vibration receiving means is configured to receive sound or vibrations propagating through and/or originating from said fluid conduit and/or fluid contained in the same.

In a preferred embodiment, the apparatus includes at least one output means. Typically, the output means is configured to output one or more electromagnetic signals when activated. Further typically, the electromagnetic signals actuates any one or any combination lights, speakers, electromechanical equipment and/or the like.

Typically, on receiving sound or vibrations in a predetermined range the sensor assembly sends a signal or activates the output means.

Typically, the sonic or vibration receiving means are sensors. Further typically the sensors include receivers and/or transducers. Further typically, the sensors include ultrasonic receivers and/or ultrasonic transducers.

In a preferred embodiment, the apparatus includes at least one surface ultrasonic sensor. Typically, the sensor is configured to detect and/or monitor ice formation in the fluid conduit.

In one embodiment, the apparatus includes at least one temperature sensor. Typically, the temperature sensor is included in the sensor assembly.

In one embodiment, the apparatus includes at least one processor means to interpret and/or process the one or more signals from the one or more sensors.

In one embodiment, the sensors or receiving means are configured to detect the characteristic click or creaking sound of ice formation within the conduit which occurs as a result of the expansion of water. Typically, an ultrasonic receiver or transducer detects this sound. Further typically, the processor means analyses the sound and to estimate the formation of ice.

In one embodiment, the processor means analyses the acoustic characteristics of the fluid conduit as ice forms.

In one embodiment, the apparatus includes at least one transducer that issues a signal or wave. Typically, the transducer is an ultrasonic transducer. Further typically, the amplitude of the wave propagating through the fluid and/or conduit is monitored by the sensor assembly.

Typically, the amplitude of the ultrasonic wave is monitored in real-time.

In one embodiment, the apparatus includes a conduit cooling member. Typically, the conduit cooling member includes at least one portion that is adapted to fit around at least a portion of the conduit or pipe in use.

In one embodiment, the conduit cooling member includes at least one sensor. Typically, the conduit cooling member includes at least one ultrasonic sensor or transducer and/or a temperature sensor or thermocouple.

In one embodiment, the conduit cooling member includes a coolant feed means to transfer coolant to the portion adapted to fit around at least part of the conduit or pipe in use. Typically the portion is a jacket to which coolant or refrigerant can be fed and/or circulated.

In one embodiment, the conduit cooling member includes a thermoelectric device or circuit to cool the section of conduit or pipe. Typically, the thermoelectric device uses the Peltier effect to cool or freeze the conduit surface and fluid therein.

Preferably, the fluid in the conduit is substantially stationary or not flowing during freezing.

In one embodiment, the supply or feed of coolant and/or power supplied to the thermoelectric device is dependent and/or calculated on the one or more vibrations and/or sonic signal received by the apparatus. Typically, the processing means receives signals from the sensors and calculates the required output and/or activation of the output means.

In one embodiment, the output means includes one or more lights or displays that indicate the status of the freezing of the pipe contents. Typically, the output means includes an LCD.

In a second aspect of the disclosure, there is provided a method of freezing part or a section of a fluid conduit. The method includes attaching an apparatus at least part of which is configured to be attached to and/or located adjacent to a fluid conduit, where the apparatus including a sensor assembly including at least one sonic or vibration receiving means characterised in that said sonic or vibration receiving means is configured to receive sound or vibration frequencies propagating through and/or originating from said fluid conduit and/or fluid contained in the same.

Preferably, the fluid conduit is a water pipe or pipe carrying liquid water. Typically, the freezing or ice formation is detected and/or monitored in real time.

In a third aspect of the disclosure, there is provided a system suitable for monitoring and/or detecting the freezing of water to form a plug in a section or part of a pipe. At least part of the system including a device configured to be attached to and/or located adjacent to a pipe in use, and including at least one sonic or vibration receiving means characterised in that said sonic or vibration receiving means is configured to receive sound or vibrations propagating through and/or originating from said fluid conduit and/or fluid contained in the same.

Typically, the condition or phase of the water can be detected and/or monitored from the amplitude and/or frequency of the sounds and/or vibrations received. Further typically, the receiving means are ultrasonic sensors.

In a further aspect of the disclosure, there is provided a pipe freeze detecting or monitoring system. The system includes securing at least part of a device configured to be attached to and/or located adjacent to a fluid conduit in use, and including at least one sonic or vibration receiving means characterised in that said sonic or vibration receiving means is configured to receive sound or vibrations propagating through and/or originating from said fluid conduit and/or fluid contained in the same.

Typically, the processor means is a microcontroller.

In one embodiment, the apparatus includes a wireless communication module. Typically, the wireless communication module is a Bluetooth™ and/or BLE module to enable wireless communication with one or more electronic devices. Further typically, the electronic devices includes portable and/or hand held devices such as laptops, cellular phones, tablets and the like.

In one embodiment, the wireless device includes an app or software application to control the device.

Specific embodiment of the disclosure are now described with reference to the following figures wherein:

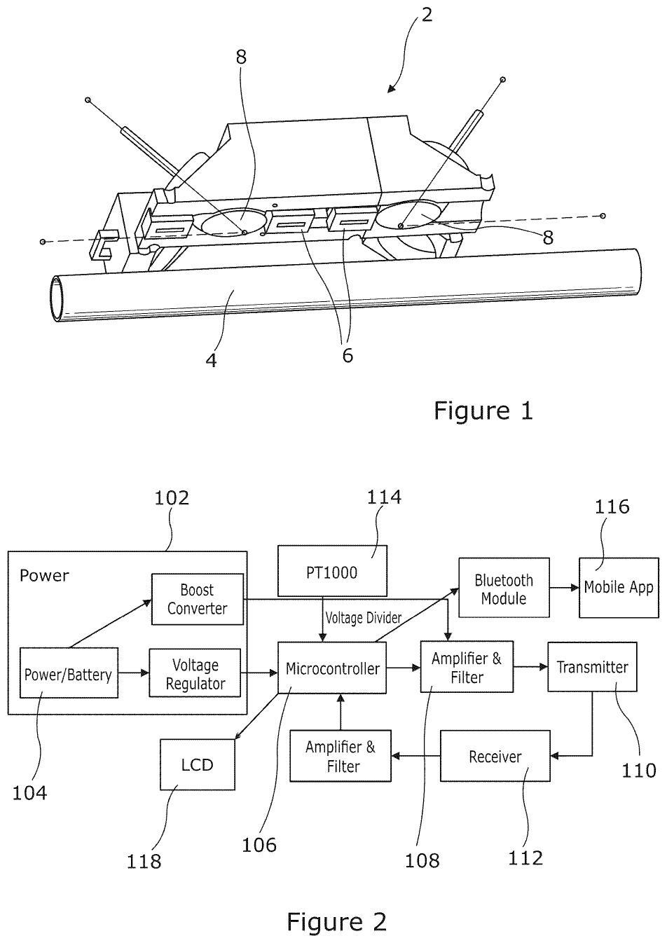

FIG. 1 shows a device in accordance with one embodiment of the invention; and

FIG. 2 shows the electrical layout of a device in accordance with one embodiment of the invention.

The present disclosure concerns a device for the ‘smart’ freezing of pipes. In particular, the use of sensors to monitor the stages of ice formation in the pipe.

In order to achieve this, one or more sensors are used to monitor the ice formation in real-time. A surface ultrasonic sensor is used for smart monitoring and this can be used in conjunction with a temperature sensor. As a result, the stages of ice formation and deformation can be detected in real-time as the pipe is cooled.

Cooling can be achieved by refrigerant passed into a jacket. Also, electrical cooling, for example Peltier cooling, can be used to freeze the pipe.

Using the surface ultrasonic sensor, two approaches can used in to monitor the ice formation.

The first is a passive method. One of the major characteristics of ice in pipe is a characteristic creaking sound which occurs as a result of the expansion of water. With the help of an ultrasonic receiver, this sound can be detected and used that to estimate the total formation of ice.

The second is an active method: This uses the analysis of acoustic characteristic of the pipe as ice forms. Using the ultrasonic sensors, an ultrasonic wave is propagated and the amplitude of the ultrasonic wave is monitored in real-time.

If a temperature sensor is used to determine the stage of ice formation, then typically a Resistance Temperature Detector (RTD) sensor is used to read the real-time temperature of the pipe surface.

Using the unsteady state conduction analysis of heat transfer, the temperature of the content (water) of the pipe is estimated.

Turning to FIG. 1 where is shown a device 2 that monitors the formation of an ice plug (not shown) in the pipe 4. The device includes optional temperature sensors 6 and ultrasonic sensors 8. The device 2 is usually strapped to the pipe using a jacket (not shown) and then a supply of refrigerant or coolant is provided to the same to cool the pipe and the liquid water inside. As the coolant takes effect, the temperature sensors 6 monitor the cooling to the point of freezing and below. Also the ultrasonic sensors 8 receive vibration signals monitoring for the characteristic creak sound that accompanies the expansion and freezing of the water molecules. When the creak sound is received from the ice formation, an indication to the user is provided, usually in the form of an indication on a display and/or signal.

The signals are processed and an indication is given to the user of the device that the plug has formed and the pipe is frozen.

FIG. 2 shows an example of the electronics that can be used to control the device 2. Usually the device includes a power supply unit 102 which in this example is a number of battery cells 104 that supply power to the microcontroller 106 and transmitter amplifier and filter 108 usually via a voltage regulator or boost converter. In this example the device is configured for the active method where the analysis of the acoustic characteristic of the pipe as ice forms is monitored using the ultrasonic sensors, wherein the transmitter 110 propagates a signal and the receiver 112 receives or senses the return signals and feeds them back to the microcontroller 106 such that the amplitude of the ultrasonic wave is monitored in real-time.

The electronics in this example have option features such as the temperature sensors 114 and wireless control and/or monitoring via a mobile app 116 on a mobile device. The LCD 118 provides information as to the status of the pipe freezing and when the characteristic signal is received on formation of the ice plug is received and processed.

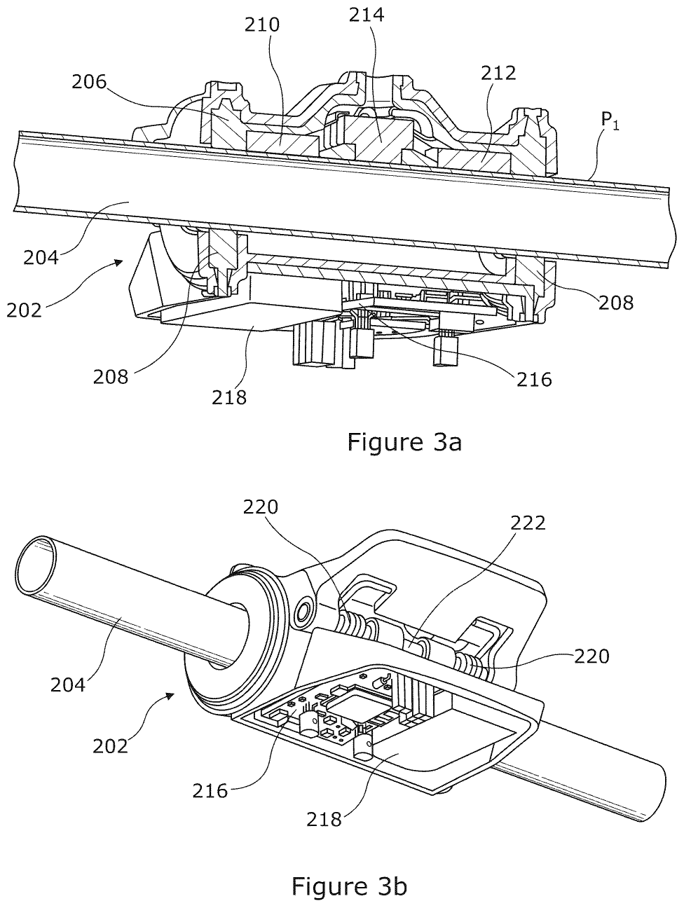

FIG. 3a shows a cross sectional view of a device 202 which is clipped around a pipe 204 in use and held in place using spring clamp arrangement. Pipe seal portions 206, 208 provide points of contact between the device 202 and the pipe 204 where cooling is delivered and the ice plug forms. Optional temperature sensors 210, 212 are located adjacent and monitor the temperature of the cooled pipe. The ultrasonic sensor 214 is centrally located between the pipe seal portions and is configured to detect the characteristic creak that is created by the forming or formed ice plug.

In this example the printed circuit board 216 is integral to the device and is powered by a battery unit 218 which may be single use or rechargeable.

FIG. 3b shows the device with part of the housing removed to show the PCB 216 and the battery 218. Also visible are the springs 220 which bias the clamp into a closed position and the pin or dowel 222 around which the clamp rotates or pivots.

What is claimed is:

1. An apparatus configured to be attached to and/or located adjacent to a fluid conduit in use, where the apparatus includes a sensor assembly including at least one of a sonic sensor or a vibration sensor characterised in that the at least one of the sonic sensor or the vibration sensor is configured to respectively receive a sound or a vibration propagating through and/or originating from the fluid conduit and/or a fluid contained in the fluid conduit.

2. The apparatus of claim 1, wherein the sensor assembly includes the sonic sensor.

3. The apparatus of claim 1, wherein the sensor assembly includes the vibration sensor.

4. An apparatus, comprising:
a clamp including a first contact portion and a second contact portion that are spaced apart to define a first region, wherein the clamp includes at least one of (i) a jacket that circulates a coolant adjacent to the first region or (ii) a thermoelectric module that enables cooling of the first region;
an ultrasonic transducer mounted on the clamp;
a transmitter circuit electrically connected to the ultrasonic transducer;
a receiver circuit electrically connected to the ultrasonic transducer;
a microcontroller electrically connected to the transmitter circuit, the receiver circuit, and at least one of the jacket or the thermoelectric module,
wherein, when the clamp clamps a wall of a conduit at a second region via the first contact portion and the second contact portion, the microcontroller enables (a) the transmitter circuit to drive the ultrasonic transducer to transmit a quantity of ultrasonic energy into the wall, (b) the ultrasonic transducer to convert a reflection of the quantity ultrasonic energy into an electrical signal, (c) the receiver circuit to receive the electrical signal from the ultrasonic transducer, (d) the receiver circuit to provide the electrical signal to the microcontroller, (e) the microcontroller to determine an amplitude value from the electrical signal, and (f) the microcontroller to control an operating parameter including at least one of a flow rate of the coolant through the jacket or a level of electrical power supplied to the thermoelectric module as a function of the amplitude value whereby at least one of the jacket circulates the coolant adjacent to the wall at the flow rate or the thermoelectric module cools the wall at the level of electrical power to enable a fluid to be frozen in the second region and formation of an ice plug in the second region to be confirmed based on the electrical signal.

5. The apparatus of claim 4, wherein the clamp includes the jacket.

6. The apparatus of claim 4, wherein the clamp includes the thermoelectric module.
